(19) United States
(12) Patent Application Publication
(10) Pub. No.: US 2010/0203856 A1
(43) Pub. Date: Aug. 12, 2010

(54) RECEPTION MODULE AND RECEPTION APPARATUS INCLUDING THE SAME

(76) Inventor: Tsutomu JITSUHARA, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/769,920

(22) Filed: Apr. 29, 2010

(30) Foreign Application Priority Data
Aug. 27, 2008 (JP) 2009-196423

(51) Int. Cl. H04B 1/18

(52) U.S. Cl. 455/150.1

(57) ABSTRACT

A reception module includes a tuner for performing a tuning process on a received broadcasting signal, a signal processing device for performing a predetermined process on the broadcasting signal after the tuning process, a first memory which is used as a working region for the signal processing device, and a second memory which stores a program for operating the signal processing device, in which the individual elements are disposed on the same component side of a circuit board, and the tuner is disposed in a first space on the component side, the signal processing device is disposed in a second space that is located substantially in the middle on the component side, the first memory and the second memory are disposed in a third space on the component side, and the first space and the third space are located on the opposite sides with respect to the second space. The reception module is capable of suppressing influence of noise generated by the memory to operations of the tuner as much as possible with a main component group and without preventing downsizing as much as possible.

### CROSS-REFERENCE TO RELATED APPLICATIONS

This application is based on Japanese Patent Application No. 2009-196423 filed on Aug. 27, 2009, the contents of which are hereby incorporated by reference.

### BACKGROUND OF THE INVENTION

1. Field of the Invention

The present invention relates to a reception module incorporated in a reception apparatus for receiving broadcasting signals and a reception apparatus including the same.

2. Description of Related Art

Conventionally, reception apparatuses for receiving broadcasting signals (e.g., terrestrial digital broadcasting signals) are widely used. Such a reception apparatus may be manufactured so that a general purpose module (reception module) having a part of necessary functions is incorporated in a main body of the reception apparatus. With this manufacturing method, it can be expected to improve efficiency in manufacturing the reception apparatus.

Here, a structure of the reception apparatus including the reception module will be described briefly with reference to an example. FIG. 4 is a diagram illustrating a structure of the reception apparatus. As illustrated in FIG. 4, the reception apparatus 301 includes an RF signal connector 316, a reception module 313, a control portion 311, a power supply portion 315, a video and audio output circuit 314, and the like. These elements are mounted on a circuit board (main circuit board).

The RF signal connector 316 is connected to an antenna 302 so that a broadcasting signal of a received terrestrial digital broadcasting (digital broadcasting signal) is supplied to the reception module 313. The reception module 313 includes a tuner circuit portion 325, a signal processing IC 321, a DRAM (Dynamic Random Access Memory as a type of RAM) 322, a flash memory 323, and the like, which are mounted on another circuit board (sub circuit board).

The digital broadcasting signal supplied from the RF signal connector 316 to the reception module 313 is first processed by tuning and is converted into an intermediate frequency state in the tuner circuit portion 325. Then, the digital broadcasting signal is further sent to the signal processing IC 321, in which a demodulation process, a decompressing process, a D/A conversion process, and the like, so as to generate analog video and audio signals. The video and audio signals are delivered to an external video display apparatus 303 (display and a speaker) via the video and audio output circuit 314.

Note that the DRAM 322 is used as a working region of the signal processing IC 321 (working memory). In addition, the flash memory 323 is used as a memory for storing a program for operating the signal processing IC 321. In addition, the control portion 311 controls the reception module 313 and the like appropriately so that the reception apparatus 301 can exert its functions, and power supply portion 315 supplies electric power to the reception module 313 and the like in accordance with an instruction of the control portion 311.

In addition, the sub circuit board that is used for forming the reception module 313 is provided with connection terminals for connecting the individual elements of the reception module 313 with external portions (the main body side of the reception apparatus 301). The reception module 313 works as a part of the reception apparatus 301 when the sub circuit board is attached to the main circuit board and the connection terminals are connected to elements on the main circuit board.

The above-mentioned reception module includes components for tuning process (the tuner circuit portion 325), components for performing necessary process on the tuned broadcasting signal (the signal processing IC 321), and memories necessary for the processes (the DRAM 322 and the flash memory 323) (referred to as “main component group” for convenience sake). With this main component group, the reception module can perform many processes that are generally necessary in the reception apparatus.

In recent years, demands for a small size of the reception apparatus is further increasing. In the case of the reception apparatus in which the reception module is incorporated as described above, it is important to make the reception module as small as possible for achieving a small size of the reception apparatus.

However, as promoting the downsizing, a space that can be secured in the reception module is decreased so that elements in the reception module become close to each other. Therefore, a malfunction of the reception module is apt to occur due to noise generated in the reception module.

Particularly, as described above, in the case of the reception module having the main component group, digital noise generated from each memory may cause a malfunction of the tuner, resulting in deterioration of reception performance of the reception apparatus. Further, if an electromagnetic shield or the like is provided additionally for reducing influence of noise, it may cause an obstacle for downsizing and cost reduction of the reception module, which is not preferable.

### SUMMARY OF THE INVENTION

The present invention is created for solving the above-mentioned problem, and an object of the present invention is to provide a reception module equipped with a main component group that can reduce influence of noise generated from a memory to a tuner operation as much as possible without preventing downsizing thereof as much as possible, and a reception apparatus including the reception module.

In order to achieve the above-mentioned object, a reception module according to the present invention, which is incorporated in a reception apparatus for receiving broadcasting signals, includes a tuner for performing a tuning process on the received broadcasting signal, a signal processing device for performing a predetermined process on the broadcasting signal after the tuning process, a first memory which is used as a working region for the signal processing device, and a second memory which stores a program for operating the signal processing device, in which the individual elements are disposed on the same component side of a circuit board, and concerning a layout on the component side, the tuner is disposed in a first space on the component side, the signal processing device is disposed in a second space that is located substantially in the middle on the component side, the first memory and the second memory are disposed in a third space on the component side, and the first space and the third space are located on the opposite sides with respect to the second space.

According to this structure, the signal processing device is disposed between the tuner and the memories (the first memory and the second memory). Therefore, the signal processing device performs a function based on an electromagnetic shield, so that influence of noise generated by each memory to operations of the tuner can be suppressed as much as possible without providing an additional electromagnetic shield or the like.

Further, in the above-mentioned structure, the broadcasting signal may be a terrestrial digital broadcasting signal including video and audio information, the tuner may also perform a process of converting the received broadcasting signal into a state of an intermediate frequency, and the signal processing device may include a digital demodulation circuit portion which receives the broadcasting signal from the tuner and performs a demodulation process on the broadcasting signal, a video and audio demodulation circuit portion which decodes the compressing process performed on the broadcasting signal after the demodulation process so as to obtain a digital video and audio signal, and a video and audio generation circuit portion which converts the digital video and audio signal into an analog video and audio signal.

According to this structure, when a terrestrial digital broadcasting signal is supplied, an analog video and audio signal related to the broadcasting can be generated.

Further, in the above-mentioned structure, the first memory may be a RAM while the second memory may be a flash memory, and another flash memory for storing EPG data obtained from the broadcasting signal may be disposed on the surface opposite to the component side of the circuit board.

According to this structure, it is easy to store the obtained EPG data and to use it if necessary. In addition, it is possible to secure a space for arranging the other flash memory without enlarging the circuit board. As a result, it is easy to downsize the reception module without an obstacle.

Further, in the above-mentioned structure, a contour of the component side may be substantially rectangular, the first space, the second space, and the third space are arranged in this order along the direction in which a first side that is a side of the contour of the component side extends, a first terminal group and a second terminal group each of which includes a plurality of connection terminals that are used for connection with outside are disposed on the circuit board, the first terminal group may be arranged along the first side, and the second terminal group may be arranged along a second side that is opposed to the first side.

Further, in the above-mentioned structure, the connection terminal disposed close to the first space in the first terminal group may be connected to the tuner as a signal input terminal, and the tuner performs the tuning process on the broadcasting signal supplied from outside via the signal input terminal.

According to this structure, it is possible to keep a transmission line of the broadcasting signal from outside to the tuner away from the memories (the first memory and the second memory) as much as possible. As a result, it is possible to reduce a probability that noise generated from the memory enters the transmission line, so that deterioration of reception performance can be prevented more.

Further, in the above-mentioned structure, the connection terminal disposed substantially in the middle of the first terminal group may be connected to the signal processing device as a signal output terminal, and the signal processing device may deliver the analog video and audio signal externally via the signal output terminal.

According to this structure, it is possible to locate the transmission line of the video and audio signal from the signal processing device to outside relatively away from the memories (the first memory and the second memory). As a result, it is possible to reduce a probability that digital noise generated from the memories enters the transmission line, so that deterioration of video and audio quality can be prevented more.

Further, in the above-mentioned structure, the connection terminal disposed close to the first space in the second terminal group may be connected to a device disposed on the circuit board as a power source terminal, and the device connected to the power source terminal may be supplied with power externally via the power source terminal.

According to this structure, it is possible to keep the power transmission line (power supply line) from outside away from the memories (the first memory and the second memory) as much as possible. As a result, it is possible to reduce a probability that digital noise generated from the memories enters the transmission line, so that deterioration of reception performance or video and audio quality can be prevented more.

Further, in the above-mentioned structure, the connection terminal disposed substantially in the middle of the second terminal group may be connected to a device disposed on the circuit board as a control terminal, and the device connected to the control terminal may operate in accordance with a control signal supplied externally via the control terminal.

According to this structure, it is possible to locate the transmission line of the control signal from outside relatively away from the memories (the first memory and the second memory). As a result, it is possible to reduce a probability that digital noise generated from the memories enters the transmission line, so that deterioration of reception performance or video and audio quality can be prevented more.

In addition, a reception apparatus according to the present invention is a reception apparatus for receiving terrestrial digital broadcasting signals and includes a reception module having the above-mentioned structure. According to this structure, it is possible to enjoy the merit obtained by the reception module having the above-mentioned structure.

### BRIEF DESCRIPTION OF THE DRAWINGS

The above-mentioned and other objects and features of the present invention will be apparent from the description about preferred examples with reference to the attached drawings as follows.

FIG. 1 is a diagram illustrating a general structure of a reception apparatus according to an embodiment of the present invention.

FIG. 2 is an explanatory diagram illustrating a layout of elements of the reception apparatus according to the embodiment of the present invention.

FIG. 3 is an explanatory diagram illustrating a layout of elements on the underside of the reception module according to the embodiment of the present invention.

FIG. 4 is a diagram illustrating a structure of an example of a conventional reception apparatus.

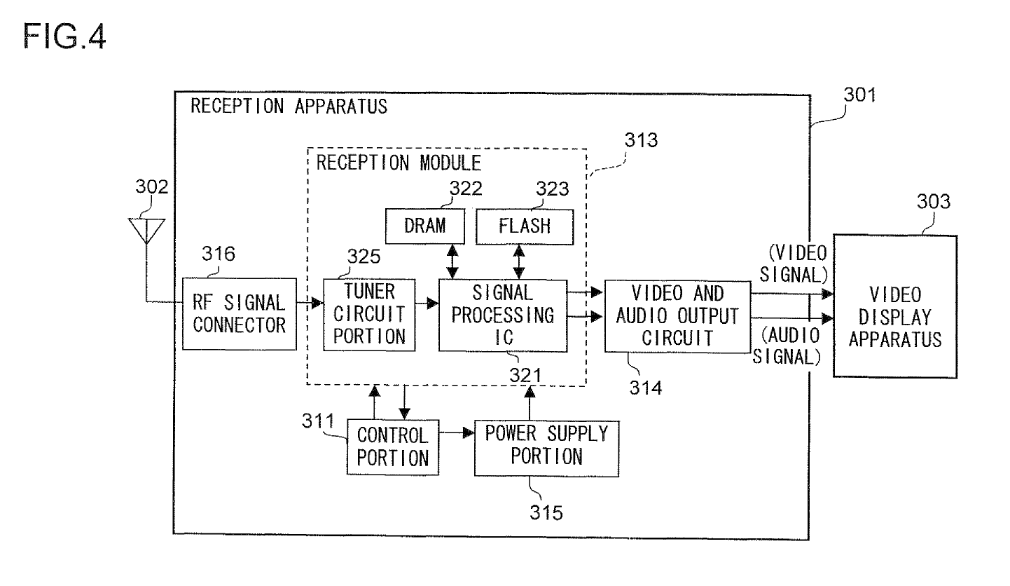

### DETAILED DESCRIPTION OF THE PREFERRED EMBODIMENTS

An embodiment of the present invention will be described below with reference to an example of a reception apparatus for receiving a terrestrial digital broadcasting signal (digital broadcasting signal). Note that the digital broadcasting signal includes video and audio information in a digital format, EPG data (electronic program guide information), and the like, and is broadcasted from a broadcasting station in the compressed state by a predetermined compressing process.

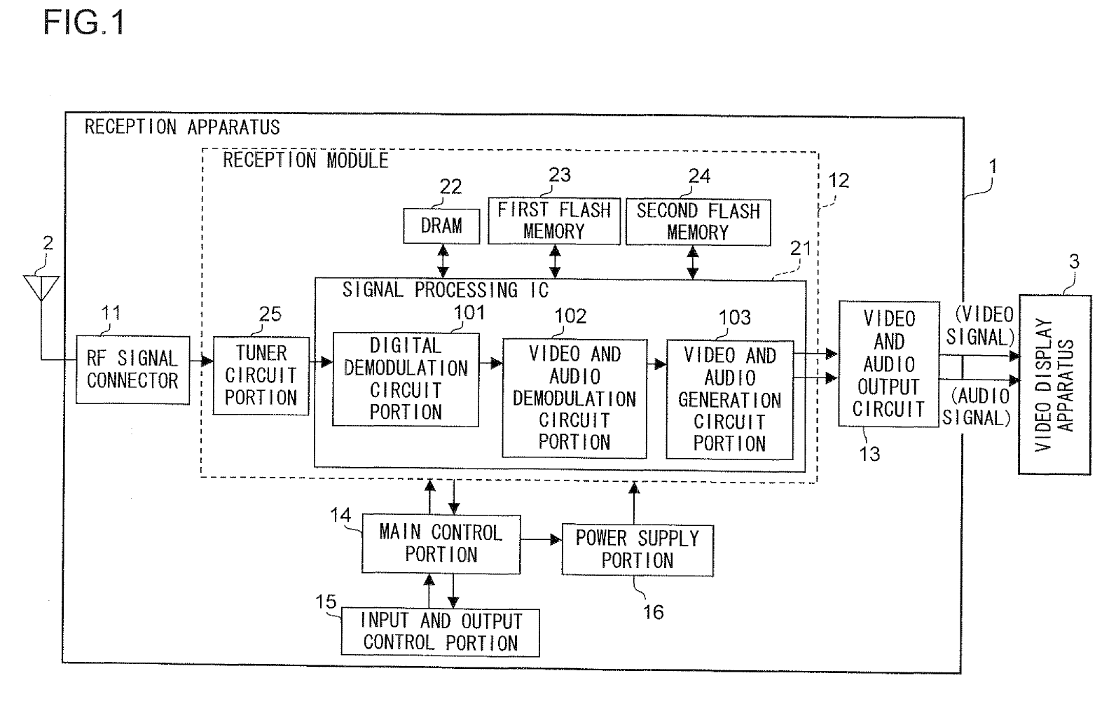

FIG. 1 is a diagram illustrating a general structure of a reception apparatus according to an embodiment of the present invention. As illustrated in FIG. 1, the reception apparatus 1 includes an RF signal connector 11, a reception module 12, a video and audio output circuit 13, a main control portion 14, an input and output control portion 15, a power supply portion 16, and the like. These elements are disposed on a component side of a circuit board (main circuit board).

The RF signal connector 11 is connected to an antenna 2 for receiving broadcasting waves, so as to supply a digital broadcasting signal (RF signal) obtained continuously via the antenna 2 to the reception module 12. In addition, the reception module 12 is constituted of a tuner circuit portion 25, a signal processing IC 21, a DRAM 22, a first flash memory 23, a second flash memory 24, and the like disposed on a component side of another circuit board (sub circuit board) separately from the main circuit board.

The tuner circuit portion 25 is a device (tuner) which performs a tuning process (a process of extracting a signal of a specified frequency) and a process of converting into an intermediate frequency (predetermined frequency) state and amplifying the same on the digital broadcasting signal sent out from the fore stage (RF signal connector 11 in the present embodiment). In this way, the tuner circuit portion 25 has a function as a general tuner, so as to realize signal processing based on a superheterodyne system.

The signal processing IC 21 is constituted of an IC (device) including functional portions such as a digital demodulation circuit portion 101, a video and audio demodulation circuit portion 102, and a video and audio generation circuit portion 103. In addition, the signal processing IC 21 is connected to the individual memories such as the DRAM 22, the first flash memory 23, and the second flash memory 24, so that the signal processing IC 21 can make access to the memories.

Note that the DRAM 22 is used mainly as a working region (working memory) of the signal processing IC 21. In addition, the first flash memory 23 is used mainly as a memory for storing a program for operating the signal processing IC 21. In other words, the signal processing IC 21 works based on the program stored in the first flash memory 23 while using the DRAM 22 as the working region. Operations of the individual functional portions in the signal processing IC 21 are as follows.

The digital demodulation circuit portion 101 performs mainly a demodulation process on the digital broadcasting signal sent from the fore stage (the tuner circuit portion 25 in the present embodiment). The video and audio demodulation circuit portion 102 performs mainly a process of decoding the compressing process (to be uncompressed state) on the digital broadcasting signal after the demodulation process.

As a result of the above-mentioned processes, the digital video and audio signal and the EPG data are obtained from the digital broadcasting signal. The video and audio demodulation circuit portion 102 sends the obtained digital video and audio signal to the video and audio generation circuit portion 103, and the obtained EPG data is stored in the second flash memory 24.

The video and audio generation circuit portion 103 converts the received digital video and audio signal into an analog video and audio signal. Then, the analog video and audio signal is sent to the post stage (the video and audio output circuit 13 in the present embodiment).

In addition, the video and audio output circuit 13 delivers the analog video and audio signal received from the fore stage to the video display apparatus 3 (including a display and a speaker) connected to the post stage of the reception apparatus 1. Thus, video display and audio output of a program of terrestrial digital broadcasting can be realized.

The main control portion 14 supplies control signals to the individual portions (including the reception module 12) of the reception apparatus 1 so that the individual portions are appropriately controlled to perform functions of the reception apparatus. The input and output control portion 15 performs control and the like concerning the input and output of signals, so as to assist operations of the main control portion 14.

In addition, the input and output control portion 15 may monitor operating states of a user interface (including operating buttons and a remote control system, for example) that is not illustrated, operated by a user, so as to transmit a user's intention (operating states) to the main control portion 14. Further, in the reception apparatus 1, turn on and off of the power supply, selection of a channel (frequency) to be tuned, and the like are instructed appropriately by the user, and the main control portion 14 operates in accordance with the instruction.

In addition, when the user instructs to output the EPG data, the main control portion 14 controls the individual portions so that the EPG data stored in the second flash memory 24 is delivered to the video display apparatus 3. Thus, the electronic program guide can be displayed on the video display apparatus 3 in accordance with an instruction of the user.

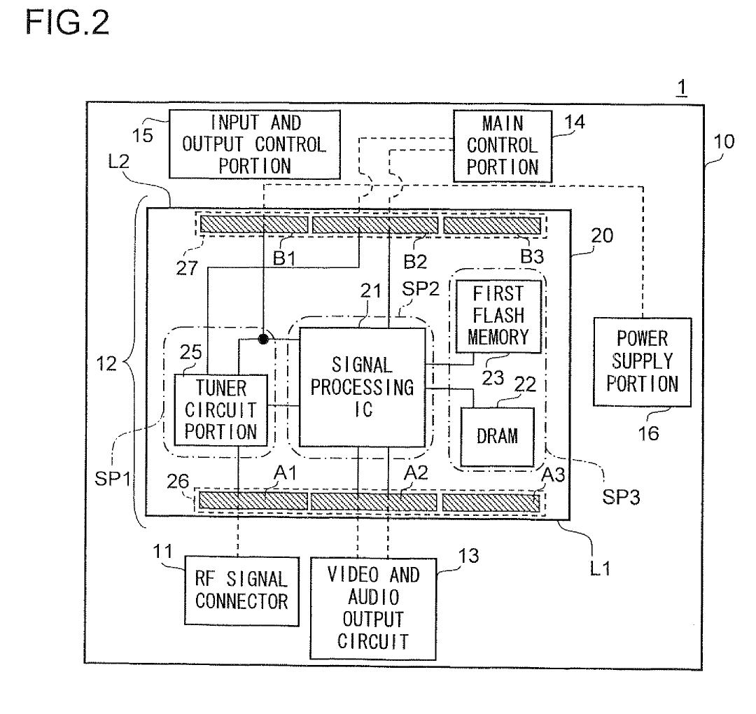

The power supply portion 16 can obtain power from a commercial power supply or a battery, for example, and the power is supplied to the individual portions (including the reception module 12) of the reception apparatus 1. Note that a layout of the individual elements of the reception apparatus 1 (in the case where the main circuit board is viewed from the top side) is as illustrated in FIG. 2.

As illustrated in FIG. 2, the individual elements (11 to 16) of the reception apparatus 1 are arranged on the component side (top side surface) of the main circuit board 10. Note that the reception module 12 is fixed to the main circuit board 10 so that the underside surface of the sub circuit board 20 faces the top side surface of the main circuit board 10. Next, the layout of the individual elements of the reception module 12 will be described in more detail.

The reception module 12 includes individual elements mounted on the sub circuit board 20 (printed circuit board) having rectangular contour and component sides on both sides. More specifically, the signal processing IC 21, the DRAM 22, the first flash memory 23, and the tuner circuit portion 25 are arranged on the top component side as illustrated in FIG. 2.

Here, the layout on the top component side of the sub circuit board 20 will be described in more detail. The signal processing IC 21 is disposed in a space SP2 located substantially in the middle on the component side. Then, the tuner circuit portion 25 is disposed in a space SP1 located between the space SP2 and one side of the contour on the component side (the left side in FIG. 2). In addition, the DRAM 22 and the first flash memory 23 are disposed in a space SP3 located between the space SP2 and one side of the contour on the component side (the right side in FIG. 2).

Note that the space SP1 and the space SP3 are located on the opposite side with respect to the space SP2. In addition, the space SP1, the space SP2, and the space SP3 are arranged in this order along the direction in which one side L1 of the contour on the component side (the lower side in FIG. 2) extends.

In this way, according to the layout on the top component side of the sub circuit board 20, the signal processing IC 21 is disposed between the tuner circuit portion 25 and the memories (22 and 23). Therefore, the signal processing IC 21 performs a function based on electromagnetic shield so as to suppress an influence of digital noise generated by the memories (22 and 23) to an operation of the tuner circuit portion 25 as much as possible.

Further, this effect can be obtained without providing an additional electromagnetic shield or the like. Therefore, it is possible to downsize the reception module 12 without an obstacle as much as possible. However, in order to suppress influence of noise more, it is possible to provide additional electromagnetic shield or the like.

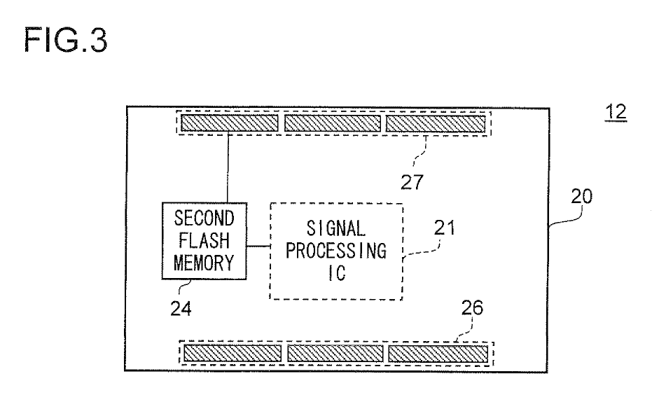

On the other hand, the second flash memory 24 is disposed on the back component side of the sub circuit board 20 as illustrated in FIG. 3. In this way, since the second flash memory 24 is disposed on the back component side (the surface opposite to the component side on which the first flash memory 23 is disposed), it is possible to secure a space for disposing the second flash memory 24 without enlarging the sub circuit board 20. As a result, it is easy to downsize the reception module 12 without an obstacle.

In addition, a first terminal group 26 is arranged so as to be along the above-mentioned side L1 on the sub circuit board 20, and a second terminal group 27 is arranged so as to be along the side L2 (the upper side in FIG. 2) that is opposed to the side L1. Each of the terminal groups (26 and 27) includes a plurality of connection terminals that are used for external connection (with other elements in the reception apparatus 1). As illustrated in FIG. 2, individual regions of the first terminal group 26 (each of which has a length that is appropriately ⅓ of the entire length) are referred to as a region A1, a region A2 and a region A3 in this order from the end close to the space SP1. Similarly, individual regions of the second terminal group 27 (each of which has a length that is appropriately ⅓ of the entire length) are referred to as a region B1, a region B2 and a region B3 from the end close to the space SP1.

The entire or a part of the connection terminals in the region A1 of the first terminal group 26 are connected to the tuner circuit portion 25 as signal input terminals. For instance, one or more connection terminals close to the space SP1 in the first terminal group 26 are the signal input terminals.

In addition, the entire or a part of the connection terminals in the region A2 of the first terminal group 26 are connected to the output side of the signal processing IC 21 (video and audio generation circuit portion 103) as signal output terminals. For instance, one or more connection terminals located substantially in the middle of the first terminal group 26 are signal output terminals.

In addition, the entire or a part of the connection terminals in the region B1 of the second terminal group 27 are connected to the devices such as the signal processing IC 21 (devices mounted on the sub circuit board 20 that require power supply) as power source terminals. For instance, one or more connection terminals in the second terminal group 27 located close to the space SP1 are the power source terminals.

In addition, the entire or a part of the connection terminals in the region B2 of the second terminal group 27 are connected to the devices such as the signal processing IC 21 (devices mounted on the sub circuit board 20 that receive the control signal) as control terminals. For instance, one or more connection terminals located substantially in the middle of the second terminal group 27 are control terminals.

When the reception module 12 is attached to the main circuit board 10 in the manufacturing step of the reception apparatus 1, the signal input terminals are connected to the RF signal connector 11, the signal output terminals are connected to the video and audio output circuit 13, the power source terminals are connected to the power supply portion 16, and the control terminals are connected to the main control portion 14. Thus, the reception module 12 can function appropriately as a part of the reception apparatus 1.

In other words, the digital broadcasting signal sent from the RF signal connector 11 is supplied to the tuner circuit portion 25 via the signal input terminal, and the tuner circuit portion 25 performs the tuning process on the signal. In addition, the analog video and audio signal sent from the signal processing IC 21 (the video and audio generation circuit portion 103) is supplied to the video and audio output circuit 13 via the signal output terminal. In addition, the signal processing IC 21 and the like are supplied with power from the power supply portion 16 via the power source terminal and are supplied with the control signal from the main control portion 14 via the control terminal.

Here, concerning the layout of the connection terminals disposed on the sub circuit board 20, the signal input terminal is disposed at the position far from the space SP3 in the first terminal group 26. Therefore, it is possible to keep the transmission line of the digital broadcasting signal from outside to the tuner circuit portion 25 away from the DRAM 22 and the first flash memory 23 (disposed in the space SP3) as much as possible. As a result, it is possible to reduce a probability that digital noise generated from the memory (22 or 23) enters the tuner circuit portion 25 or the transmission line, so that deterioration of reception performance can be prevented more.

In addition, the signal output terminal is disposed at the position far from the space SP3 in the first terminal group 26, relatively (compared with the connection terminal disposed in the region A3). Therefore, it is possible to locate the transmission line of the video and audio signal from the signal processing IC 12 to outside relatively away from the DRAM 22 and the first flash memory 23. As a result, it is possible to reduce a probability that digital noise generated from the memory (22 or 23) enters the transmission line, so that deterioration of video and audio quality can be prevented more.

In addition, the power source terminal is disposed at the position far from the space SP3 in the second terminal group 27. Therefore, it is possible to keep the power transmission line (power supply line) from outside away from the DRAM 22 and the first flash memory 23 as much as possible. As a result, it is possible to reduce a probability that digital noise generated from the memory (22 or 23) enters the power supply line, so that deterioration of reception performance or video and audio quality can be prevented more.

In addition, the control terminal is disposed at the position far from the space SP3 in the second terminal group 27, relatively (compared with the connection terminal disposed in the region B3). Therefore, it is possible to locate the transmission line of the control signal from outside (control line) relatively away from the DRAM 22 and the first flash memory 23. As a result, it is possible to reduce a probability that digital noise generated from the memory (22 or 23) enters the control line, so that deterioration of reception performance or video and audio quality can be prevented more.

Further, according to the layout on the top component side of the sub circuit board 20, the first terminal group 26 and the second terminal group 27 are disposed so as to sandwich the signal processing IC 21, the memories (22 and 23), and the tuner circuit portion 25 as illustrated in FIG. 2. In addition, the tuner circuit portion 25 is disposed in a space that is partially enclosed by the signal processing IC 21, the first terminal group 26, and the second terminal group 27, while the memories (22 and 23) are disposed in another space that is partially enclosed by the signal processing IC 21, the first terminal group 26, and the second terminal group 27.

In addition, the reception apparatus 1 of the present embodiment receives terrestrial digital broadcasting signals, but it is possible that it receives another type of broadcasting signals as a specification. In addition, it is preferable that the reception module has a certain extent of flexibility to be applied to various specifications of reception apparatuses as a structural component.

Although the embodiment of the present invention is described above, the present invention is not limited to this embodiment. In addition, the embodiment of the present invention can be modified variously within the scope of the present invention without deviating from the spirit thereof.

Further, according to the reception module of the present invention, the signal processing device is disposed between the tuner and the memories (the first memory and the second memory). Therefore, the signal processing device performs the function based on an electromagnetic shield, so that influence of noise generated by each memory to operations of the tuner can be suppressed as much as possible without providing an additional electromagnetic shield or the like.

What is claimed is:

1. A reception module incorporated in a reception apparatus for receiving broadcasting signals, the reception module comprising:
a tuner for performing a tuning process on the received broadcasting signal;
a signal processing device for performing a predetermined process on the broadcasting signal after the tuning process;
a first memory which is used as a working region for the signal processing device; and
a second memory which stores a program for operating the signal processing device, wherein
the individual elements are disposed on the same component side of a circuit board, and
concerning a layout on the component side,
the tuner is disposed in a first space on the component side,
the signal processing device is disposed in a second space that is located substantially in the middle on the component side,
the first memory and the second memory are disposed in a third space on the component side, and
the first space and the third space are located on the opposite sides with respect to the second space.

2. A reception module according to claim 1, wherein
the broadcasting signal is a terrestrial digital broadcasting signal including video and audio information,
the tuner also performs a process of converting the received broadcasting signal into a state of an intermediate frequency, and
the signal processing device includes
a digital demodulation circuit portion which receives the broadcasting signal from the tuner and performs a demodulation process on the broadcasting signal,
a video and audio demodulation circuit portion which decodes the compressing process performed on the broadcasting signal after the demodulation process so as to obtain a digital video and audio signal, and
a video and audio generation circuit portion which converts the digital video and audio signal into an analog video and audio signal.

3. A reception module according to claim 2, wherein
the first memory is a RAM while the second memory is a flash memory, and
another flash memory for storing EPG data obtained from the broadcasting signal is disposed on the surface opposite to the component side of the circuit board.

4. A reception module according to claim 3, wherein
a contour of the component side is substantially rectangular,
the first space, the second space, and the third space are arranged in this order along the direction in which a first side that is a side of the contour of the component side extends,
a first terminal group and a second terminal group each of which includes a plurality of connection terminals that are used for connection with outside are disposed on the circuit board,
the first terminal group is arranged along the first side, and
the second terminal group is arranged along a second side that is opposed to the first side.

5. A reception module according to claim 4, wherein
the connection terminal disposed close to the first space in the first terminal group is connected to the tuner as a signal input terminal, and
the tuner performs the tuning process on the broadcasting signal supplied from outside via the signal input terminal.

6. A reception module according to claim 4, wherein
the connection terminal disposed substantially in the middle of the first terminal group is connected to the signal processing device as a signal output terminal, and
the signal processing device delivers the analog video and audio signal externally via the signal output terminal.

7. A reception module according to claim 4, wherein
the connection terminal disposed close to the first space in the second terminal group is connected to a device disposed on the circuit board as a power source terminal, and
the device connected to the power source terminal is supplied with power externally via the power source terminal.

8. A reception module according to claim 4, wherein
the connection terminal disposed substantially in the middle of the second terminal group is connected to a device disposed on the circuit board as a control terminal, and
the device connected to the control terminal operates in accordance with a control signal supplied externally via the control terminal.

9. A reception apparatus for receiving terrestrial digital broadcasting signals, comprising a reception module according to claim 1.
